(19) United States
(12) Patent Application Publication
(10) Pub. No.: US 2023/0295821 A1
(43) Pub. Date: Sep. 21, 2023

(54) BACKPRESSURE REGULATION FOR MEMBRANELESS HYDROGEN ELECTROLYZER

(71) Applicant: X Development LLC, Mountain View, CA (US)

(72) Inventor: Radu Gogoana, Brisbane, CA (US)

(21) Appl. No.: 17/700,083

(22) Filed: Mar. 21, 2022

(51) Int. Cl. C25B 15/023; C25B 1/04; C25B 9/17

(52) U.S. Cl. CPC C25B 15/023; C25B 1/04; C25B 9/17

(57) ABSTRACT

A hydrogen electrolyzer system generates hydrogen and oxygen gases via electrolysis. The hydrogen and oxygen gases are exhausted to hydrogen and oxygen exhaust manifolds, respectively. An absolute pressure in one of the hydrogen or oxygen exhaust manifolds is monitored. A differential pressure between the hydrogen and oxygen exhaust manifolds is monitored. Backpressures in the hydrogen and oxygen exhaust manifolds are controlled based upon the absolute and differential pressures.

### TECHNICAL FIELD

This disclosure relates generally to hydrogen electrolyzers, and in particular, backpressure regulation of electrolysis.

### BACKGROUND INFORMATION

The world's energy demands are projected to rise for the foreseeable future. Renewable sources of energy, such as solar and wind will contribute an increasing portion of these future energy needs. Renewable energy sources will be used to charge batteries, which will replace fossil fuels as a significant energy source for many transportation needs, such as automobile transportation. However, batteries may not provide sufficient energy/power densities to satisfy the needs of certain energy intensive transportation applications such as large craft commercial air travel and trans-oceanic trips. Hydrogen and hydrogen fuel cell technologies can provide the necessary energy density to power even these highest energy demand applications. Synthetic fuels made using hydrogen as a feedstock can also target many end use energy needs that are historically difficult to decarbonize. Examples include: high-energy-density fuels required for aviation and shipping, green fuel flexibility for gas turbine power generation, and as a feedstock for various industrial production processes. As such, hydrogen-based technologies include the promise to decarbonize what grid based or battery electrification cannot.

Green technologies (e.g., low net carbon or carbon neutral technologies) for commercial production of hydrogen gas currently require immense capital expenditures. These immense capital expenditures are significant barriers to the broad-based adoption of hydrogen fuel cell technologies and hydrogen-based synthetic fuel. Commercial scale hydrogen solutions that are capable of significantly reducing these capital expenditures, thus providing plentiful hydrogen at an economically competitive price, may hasten the deployment and adoption of green hydrogen-based technologies.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 is a cross-sectional view illustrating a hydrogen electrolyzer cell, in accordance with an embodiment of the disclosure.

FIG. 2A is a perspective view illustration of a hydrogen electrolyzer stack including five cells stacked in series, in accordance with an embodiment of the disclosure.

FIG. 2B is a perspective view illustration of a hydrogen electrolyzer stack with a side cutout illustrating internal details, in accordance with an embodiment of the disclosure.

FIG. 3 is a perspective exploded view of a modular and extensible panel construction of a hydrogen electrolyzer cell, in accordance with an embodiment of the disclosure.

FIG. 4 is a cross-sectional illustration through a center of the five-cell hydrogen electrolyzer stack, in accordance with an embodiment of the disclosure.

FIG. 5 is a perspective view illustration of an array of stacks of hydrogen electrolyzer cells coupled for large scale hydrogen production, in accordance with an embodiment of the disclosure.

FIG. 6 is a functional block diagram illustrating components for regulating backpressures in a hydrogen electrolyzer system, in accordance with an embodiment of the disclosure.

FIG. 7 is a flow chart illustrating a process for starting up a hydrogen electrolyzer system and regulating backpressures during steady-state operation of the hydrogen electrolyzer system, in accordance with an embodiment of the disclosure.

### DETAILED DESCRIPTION

Embodiments of a system, apparatus, and method of operation for regulating manifold backpressures during startup and steady-state operation of a hydrogen electrolyzer system are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of a hydrogen electrolyzer cell, stack, and system described herein provide a low-cost option for generation of hydrogen while only modestly trading off efficiency for substantial capital expenditure (CAPEX) savings. The CAPEX savings are derived, in significant part, from integrating a number of expensive, conventionally distinct components into an extensible structure that may be fabricated of low-cost materials, such as injection molded thermoplastic (e.g., polypropylene). CAPEX savings are also derived from the elimination of components such as gaskets, tie rods, and compression plates that are typically used in alkaline electrolyzers. For example, it is believed that a loss of approximately 10% efficiency may be traded for roughly a 10× reduction in CAPEX when compared against conventional alkaline hydrogen electrolyzers. For commercial scale megawatt electrolyzers, this CAPEX savings may mean the difference between economically viable hydrogen production options and uneconomical options that will not be deployed. The high CAPEX of conventional hydrogen electrolyzers often requires that they operate 24/7 with little down time to achieve economic viability. In these scenarios, the use of intermittent green power generation (e.g., solar or wind power) may be precluded and thus the low or zero carbon benefit of hydrogen fuel cells and hydrogen-based synthetic fuels compared to traditional fossil fuels may be reduced or even entirely lost. In contrast, the low cost, scalable nature of the embodiments described herein is expected to be more viable for use with these intermittent green power sources.

Embodiments described herein also accrue CAPEX savings from the omission of yet another component—an electrolysis membrane. The illustrated embodiments are membraneless electrolyzers, meaning that the electrolysis membrane, through which charged ions transport to sustain the electrochemical process associated with cathodic reduction and anodic oxidation, is omitted. In other words, the illustrated hydrogen electrolyzers do not separate the electrolytic solution in the cathode and anode chambers from each other using an electrolysis membrane. Rather, the cathode and anode electrodes are bathed in a shared electrolytic solution from a shared reservoir and use chamber geometries and natural buoyance of the oxygen and hydrogen gases to maintain separation between the evolving oxygen and hydrogen gases. This elimination of the electrolysis membrane can reduce manufacturing expenses (i.e., CAPEX) in trade for more precise control over backpressures during operation. Hydrogen electrolyzers that use an electrolysis membrane are typically more tolerant of swings/deviations in differential backpressure between the hydrogen and oxygen exhaust manifolds. For example, a membrane electrolyzer may be able to tolerate differential pressures of 1 to 10 bar between the cathode and anode chambers. In contrast, without separating the cathode and anode chambers with an electrolysis membrane, membraneless electrolyzers may need greater control over pressure differentials. Embodiments described herein are able to maintain differential pressures of less than 5 mm (or even less than 3 mm) of water column height. A pressure differential of less than 3 mm of water column height is approximately equal to a pressure differential of less than 0.00029 bars, which is several orders of magnitude less than may be permitted in a conventional membrane electrolyzer.

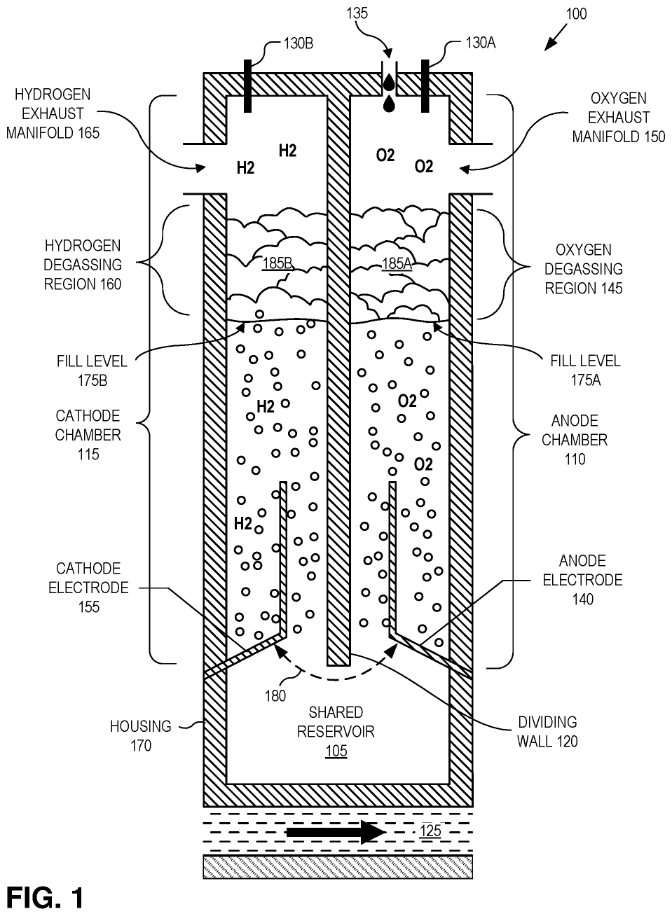

FIG. 1 illustrates a hydrogen electrolyzer cell 100, in accordance with an embodiment of the disclosure. The illustrated embodiment of cell 100 includes a shared reservoir 105, an anode chamber 110 separated from a cathode chamber 115 by a dividing wall 120, a heat exchange path 125, gas sensors 130A and 130B, and a deionized (DI) water injection port 135. The illustrated embodiment of anode chamber 110 includes anode electrode 140, oxygen degassing region 145, and oxygen exhaust manifold 150. The illustrated embodiment of cathode chamber 115 includes cathode electrode 155, hydrogen degassing region 160, and hydrogen exhaust manifold 165. In the illustrated embodiment, a modular and extensible housing 170, which includes dividing wall 120, defines and encloses shared reservoir 105, anode chamber 110, cathode chamber 115, and heat exchange path 125. In other embodiments, heat exchange path 125 may be entirely omitted in favor of exterior surface convective cooling using liquid or gaseous coolants. For example, air may be blown across one or more (or all) exterior surfaces of housing 170 instead of integrating interior heat exchange path 125 within housing 170.

In one embodiment, the bulk of housing 170 is fabricated of an inexpensive, monolithic material. For example, housing 170 may be an injection molded thermoplastic (e.g., polypropylene). Of course other materials, compounds, or a combination of materials may be used depending upon a particular application. For example, housing 170 may be fabricated using a multilayer laminate construction combining multiple different materials having various desirable properties for heat resistance, mechanical strength, corrosion resistance, and/or thermal conductivity. Furthermore, housing 170 may be modular, meaning that it is assembled from multiple pieces, and extensible, meaning that it is formed from a repeating structure that facilities stacking multiple instances of the single cell 100 to increase hydrogen production. In one embodiment, the sidewalls and dividing wall 120 are approximately 1 mm thick polypropylene. Of course, other thickness may be used. Not only is monolithic construction from thermoplastic inexpensive, but the metal electrodes and plastic housing bodies may be reconditioned or recycled to further reduce the lifetime cost. Reconditioning may be achieved via in-situ pressurized flushing of the stack with other chemicals.

When deployed, shared reservoir 105, anode chamber 110, and cathode chamber 115 are filled with an electrolytic solution to fill levels 175A & 175B that entirely bathe (i.e., submerge) anode electrode 140 and cathode electrode 155 within the electrolytic solution. The electrolytic solution is a stagnant or static bath and need not be pumped, or actively circulated or recycled through the cell or cell stack during electrolysis, though passive convection currents may arise as a side effect of internal heat dissipation or frothing during degassing. During operation, the differential backpressure between hydrogen exhaust manifold 165 and oxygen exhaust manifold 150 is regulated to be less than a threshold height differential of the electrolytic solution between anode chamber 110 and cathode chamber 115. The threshold height differential between fill levels 175A and 175B is selected to ensure that a differential backpressure doesn't result in dry exposure of either anode electrode 140 or cathode electrode 155. In other words, the backpressure differential between the exhaust manifolds is closely regulated to ensure both anode electrode 140 and cathode electrode 155 always remain fully bathed in the electrolytic solution during electrolysis. Even temporary exposure of one of the electrodes can stop the electrolysis reaction. In various embodiments, the threshold height differential between fill levels 175A and 175B is equal to or less than 5 mm. In yet another embodiment, the threshold height differential between fill levels 175A and 175B is equal to or less than 3 mm (e.g., approximately a 0.0042 psi pressure imbalance).

In one embodiment, the electrolytic solution is an alkaline solution (base), such as aqueous potassium hydroxide (KOH) having 25% KOH and 75% water. Other electrolytes and/or electrolytic concentrations may be used. The electrolytic solution may include other additives such as antifouling agents or surfactants. The antifouling agents may be used to reduce biofouling, reduce chemical buildup, suppress undesirable side reactions, improve performance, or otherwise. The surfactants may be used to affect the diameter of the hydrogen/oxygen bubbles rising within cathode chamber 115 or anode chamber 110, or otherwise. As the water in the electrolytic solution is consumed during electrolysis, it may be replenished by direction injection of deionized water via DI water injection port 135.

Divider wall 120 extends up from shared reservoir 105 and separates anode chamber 110 from cathode chamber 115 in the upper portion of cell 100. In one embodiment, dividing wall 120 extends equal to or below the bottom of the electrodes 140 and 155 exposed to the electrolytic solution. Dividing wall 120 terminates at the top of shared reservoir 105, which is open between the two chambers to permit transport of charged ions within the electrolytic solution under dividing wall 120 through shared reservoir 105 along conduction path 180 between anode electrode 140 and cathode electrode 155. In one embodiment, the height of shared reservoir 105 below dividing wall 120 is approximately equal to the width of each of anode chamber 110 and cathode chamber 115. Of course, other dimensions may be implemented. Dividing wall 120 is a solid non-permeable wall that blocks transport of charged ions forcing the conduction path 180 down around its distal/bottom end. Similarly, dividing wall 120 blocks mixing of the hydrogen and oxygen gases released during electrolysis. During operation, the oxygen and hydrogen gases bubble up, or evolve, in their respective chambers forming froths 185A and 185B (collectively referred to as froth 185) in oxygen degassing region 145 and hydrogen degassing region 160, respectively. The vertical orientation of anode chamber 110 and cathode chamber 115 facilitates this passive, buoyancy-driven separation of the oxygen and hydrogen gases during electrolysis without need of a dividing electrolysis membrane. The integrated degassing regions significantly reduces the need for expensive external phase separators/demisters that are corrosion resistant. The height of degassing regions may be selected to ensure froth 185 does not spill over into exhaust manifolds 150 and 165 for a desired operational drive current. If froth 185 does spill over into either exhaust manifold 150 or 165, a shunting current path may be established degrading performance and may contaminate the exhaust manifolds and connecting plumbing with the caustic electrolytic solution.

Embodiments of hydrogen electrolyzer cell 100 operate without need of expensive catalysts or membranes disposed between the electrodes as used in conventional electrolyzers. Hydrogen electrolyzer cell 100 is membraneless because conduction path 180 for the transport of ions between the electrodes does not pass through an electrolyzer membrane that otherwise separates/isolates the two chambers from each other. In the illustrated embodiment, anode electrode 140 and cathode electrode 155 are both fabricated from metal, such as nickel. In one embodiment, anode electrode 140 and cathode electrode 155 are fabricated from a metal mesh, such as a nickel metal mesh. A woven metal mesh, an expanded metal mesh, an expanded metal foam, a metal foil, a perforated metal, an expanded metal foil, nanostructured metal features on a foil, or otherwise may also be used. Anode electrode 140 and cathode electrode 155 may assume a variety of different sizes and shapes, such as metallic foams or other 3-dimensional structures. For example, the surfaces of the electrodes may be roughened to increase overall surface area in contact with the electrolytic solution. In one embodiment, anode electrode 140 and cathode electrode 155 may each be 2 cm long, though the electrodes need not be symmetrical. In yet other embodiments, the distal tips of electrodes may be folded over to keep more surface area of the electrodes closer to the bottom tip of dividing wall 120, thereby reducing the resistance of conduction path 180. Additionally, one or both of electrodes 140 and 155 may include integrated or coated catalysts, such as palladium, iridium, etc.

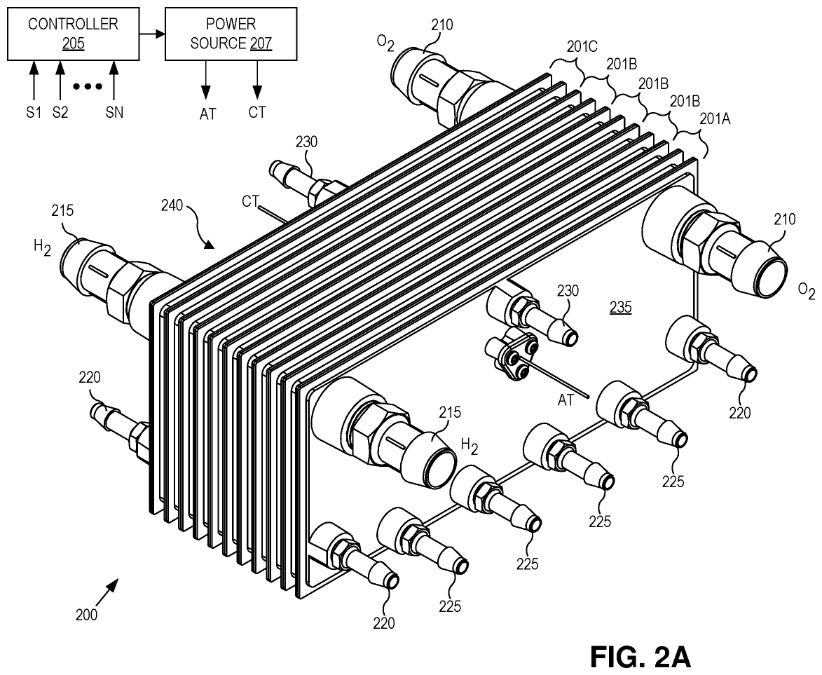

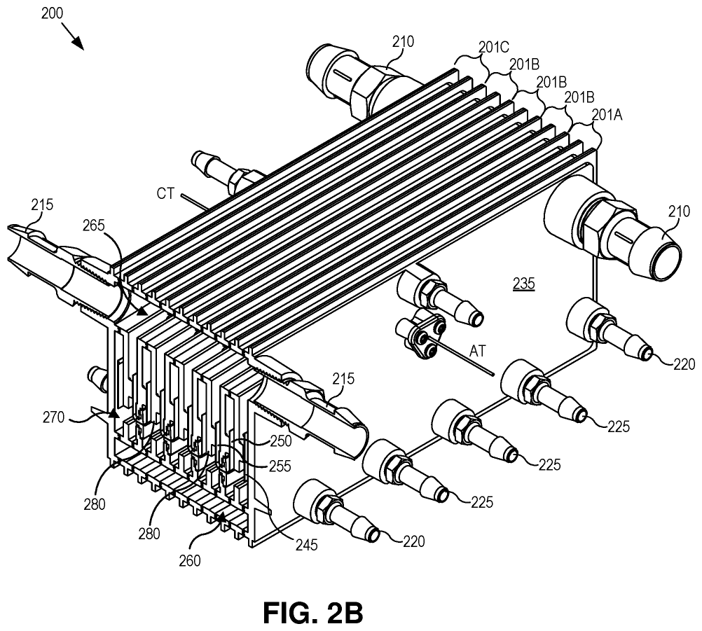

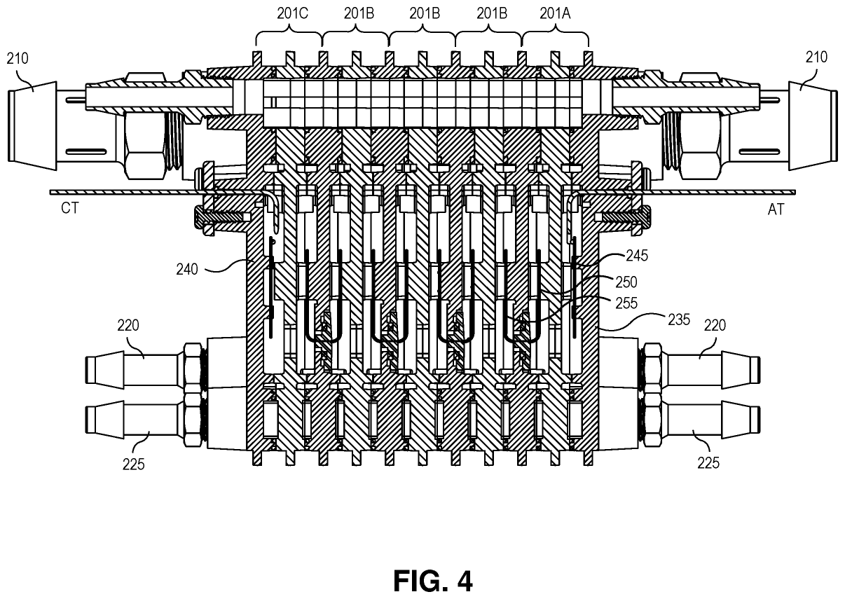

As discussed in more detail below in connection with FIG. 2B and FIG. 4, anode electrode 140 and cathode electrode 155 of adjacent electrolyzer cells in a stack of series connected cells may be implemented as joint electrodes formed from a single contiguous piece of metal (or metal mesh) bent into a U-shape or a V-shape that is embedded in and passes through the sidewall of housing 170. In one embodiment, the sidewalls of housing 170 are over-molded on top of the joint electrodes, to seal and separate the electrolytic solution in adjacent chambers.

As previously mentioned, oxygen exhaust manifold 150 is integrated into anode chamber 110 to export oxygen from cell 100, while hydrogen exhaust manifold 165 is integrated into cathode chamber 115 to export hydrogen gas from cell 100. Both oxygen exhaust manifold 150 and hydrogen exhaust manifold 165 are extensible for coupling to adjacent hydrogen electrolyzer cells in a stack. Again, by integrating the exhaust manifolds into the extensible/modular structure of housing 170 itself, costs associated with stacking large numbers of hydrogen electrolyzer cell 100 are reduced.

Similar to the other extensible components, heat exchange path 125 is also integrated into housing 170 and designed to connect with heat exchange paths 125 of adjacent cells stacked in series. In the illustrated embodiment, heat exchange path 125 is disposed adjacent to (e.g., under) shared reservoir 105 to exchange heat with the electrolytic solution. During regular operation, heat may be carried away from the electrolytic solution via circulating a heat exchange fluid (e.g., a water glycol coolant mixture, other liquid coolants, gaseous coolants, etc.) through heat exchange path 125. During a startup process, the heat exchange fluid may be preheated to a desired startup temperature to aid with startup of the electrolysis. This may be done by a heater within the coolant loop, or alternatively by running the electrolysis process in a deliberately inefficient operating regime, such as by using a higher voltage per cell than normal operation, to generate heat internally for bringing the system up to its optimal operating temperature. In an embodiment wherein housing 170 is fabricated of injection molded thermoplastic, the electrolytic solution may be cooled to maintain an operating temperature of approximately 95 degrees Celsius. This operating temperature is limited by the mechanical properties of the thermoplastic; for example, some thermoplastics that are more expensive than polypropylene can handle higher temperatures before deformation, such as polysulfone. The exhaust manifolds may be operated at atmospheric pressure, or a backpressure applied to elevate the boiling point of the electrolytic solution and operate at higher temperatures and pressures depending upon the material or materials selected to form housing 170. Operating at higher temperatures and/or pressures may increase operating efficiency though may increase the cost of the material selection for housing 170 to withstand these higher temperatures and/or pressures. Pressure regulators may be coupled to the exhaust manifolds to manage gas flows and balance backpressures between the oxygen and hydrogen exhaust manifolds.

In the illustrated embodiment, anode chamber 110 includes a gas sensor 130A and cathode chamber 115 includes a gas sensor 130B adapted to monitor for cross mixing of hydrogen and oxygen gases resulting in a combustible vapor mixture. In one embodiment, gas sensors 130A and 130B are implemented using catalytic gas detectors such as a catalytic pellistor or otherwise. Gas sensors 130A and 130B may be coupled to a controller (e.g., controller 205) configured to shut down and/or automatically purge a contaminated exhaust manifold (e.g., purge with an inert gas) in case a combustible mixture of hydrogen and oxygen is detected, due to unintentional crossover of gas bubbles below dividing wall 120. For cost efficiency reasons, these combustible gas sensors may be placed in the exhaust manifolds at the end of a stack, so that they can monitor for potentially combustible mixtures coming from multiple stacks 200 at once. While FIG. 1 illustrates a set of gas sensors 130A and B for use with the single cell 100, it should be appreciated that in a large stack-ups of cells 100, gas sensors 130A and B may be inserted into the shared exhaust manifolds at the end of a serialized stack and thus shared across many individual cells 100.

FIGS. 2A and 2B illustrate of a hydrogen electrolyzer stack 200 including multiple hydrogen electrolyzer cells 201A, B and C (collectively referred to as cells 201) stacked in series, in accordance with an embodiment of the disclosure. FIG. 2A is a perspective view illustration of stack 200 while FIG. 2B includes a side cutout illustrating internal details of stack 200. Cells 201 each represents one possible implementation of hydrogen electrolyzer cell 100 illustrated in FIG. 1. The illustrated embodiment of stack 200 includes five cells 201, an anode terminal (AT), a cathode terminal (CT), oxygen manifold ports 210, hydrogen manifold ports 215, fill/drain ports 220, heat exchange ports 225, DI water ports 230, anode end panel 235, and cathode end panel 240.

As illustrated, cells 201 may be stacked in series to form stack 200. Although FIGS. 2A and 2B illustrated just five cells 201 coupled in series, it should be appreciated that more or less cells 201 may be stacked in series. The interior cells 201B may be identical, repeatable structures sandwiched between end cells 201A and 201C. The cells 201 may be mechanically connected with fasteners and sealed with gaskets (e.g., o-rings), hot-plate welded to avoid the cost associated mechanical fasteners and gaskets, or connected and sealed using other techniques (e.g. ultrasonic welding, vibration welding, infrared welding, laser welding, etc.) or adhesives.

In one embodiment, a power source 207 is a direct current (DC) to DC converter that couples to CT and AT to apply a bias voltage across the series connected cells 201. Power source 207 may further include various intermittent power sources such as solar cells or wind turbines. A controller 205 is coupled to power source 207 and stack 200. Controller 205 may include hardware and/or software logic and a microprocessor to orchestrate operation of power source 207 and stack 200. In the illustrated embodiment, controller 205 monitors various sensor signals S1, S2 . . . SN from stack 200 and uses these feedback sensor signals to control power source 207. The sensor signals may include temperature readings, gas sensor readings, voltage readings, electrolyte level readings, etc. sourced from stack 200. During regular operation, controller 205 applies a forward bias potential across CT and AT. However, in some instances, controller 205 may periodically, or on-demand, short or reverse bias CT and AT to recondition the anode and cathode electrodes. Short circuiting or reverse biasing may be particularly beneficial for anode electrode 140 due to the buildup of surface layer nickel oxides. Reverse biasing may be at a sufficiently low voltage that does not cause electrolysis and gas production, while still reconditioning the electrodes. Alternatively, the exhaust manifolds may be purged with an inert gas before and after reverse biasing if higher reverse bias potentials are desired, to prevent the buildup of potentially flammable mixtures of oxygen and hydrogen internally. In one embodiment, electromechanical (or fluid) taps may be attached to one side of each manifold port 210 and 215 for selectively injecting an inert purging gas (e.g., nitrogen) into the hydrogen and oxygen exhaust manifolds. Flow through the taps may be electronically controlled under the influence of controller 205. A periodic reconditioning schedule may leverage the diurnal rhythms of intermittent green energy. Of course, commercial scale operations having large banks of stacked cells 201 may implement a staggered reconditioning schedule that takes one or more stacks 200 offline at a time while maintaining operation of the remaining stacks 200. An effective reconditioning schedule will reverse electrode degradation while recovering and/or maintain operating efficiencies over longer durations. The above identified control strategies serve to potentially increase electrode and stack life well beyond conventional electrolyzer lifespans of approximately 7 years. For example, useful lifespans exceeding 20 years may be possible using these control strategies.

Correlating FIG. 2A to FIG. 1, fill/drain ports 220 connect to shared reservoir 105 of cells 201 to fill or drain the electrolytic solution. Heat exchange ports 225 couple to heat exchange path 125 of cells 201 to circulate a heat exchange fluid through stack 200 for temperature regulation. Since heat exchange path 125 is isolated from the caustic electrolytic solution, inexpensive air-to-liquid heat exchangers may be used to circulate and cool the heat exchange fluid. These air-to-liquid heat exchangers may be fabricated of less expensive aluminum as opposed to stainless steel, which is typically used when circulating the electrolytic solution itself. Oxygen manifold ports 210 connect to oxygen exhaust manifold 150 of each cell 201 to export oxygen gas from the stack 200 while hydrogen manifold ports 215 connect to hydrogen exhaust manifold 165 of each cell 201 to export hydrogen gas from stack 200. DI water ports 230 couple to DI water injection port 135 of each cell 201. Finally, cathode terminal CT connects directly to cathode electrode 155 of a first end cell 201C while anode terminal AT connects directly to anode electrode 140 of the other end cell 201A.

FIG. 2B includes a side cutout of hydrogen electrolyzer stack 200 illustrating internal details, in accordance with an embodiment of the disclosure. Anode terminal AT directly connects to anode electrode 245 of end panel 235 of end cell 201A. As illustrated, cathode electrode 250 of end cell 201A and anode electrode 255 of adjacent interior cell 201B form a joint electrode having a U-shape that is embedded in and passes through the shared sidewall between these adjacent cells. Half of the joint electrode is a cathode for end cell 201A while the other half is an anode for the adjacent interior cell 201B. This U-shaped joint electrode is illustrated in greater detail in FIG. 4. Of course, other cross-sectional shapes, such as a V-shape, may be implemented with the joint electrodes.

Returning to FIG. 2B, the heat exchange path of each cell 201 aligns to and joins with the heat exchange path of its adjacent cells to form an extensible heat exchange path 260 that runs the length of stack 200 and connects to heat exchange ports 225. Similarly, the hydrogen exhaust manifold of each cell 201 aligns to and joins with the hydrogen exhaust manifold of its adjacent cells to form an extensible hydrogen exhaust manifold 265 that runs the length of stack 200 and connects to hydrogen manifold ports 215. A similar structure applies to the oxygen exhaust manifold. Shared reservoir 270 is also extensible when adding cells. In one embodiment, equalization ports are formed through sidewalls of the cells 201 to allow the electrolytic solution to be filled via fill/drain ports 220, spread to each cell 201, and fill to a common fill level 175 throughout stack 200. Finally, FIG. 2B further illustrates dividing walls 280 (not all are labelled in FIG. 2B) that extend down to the top of the extensible shared reservoir 270.

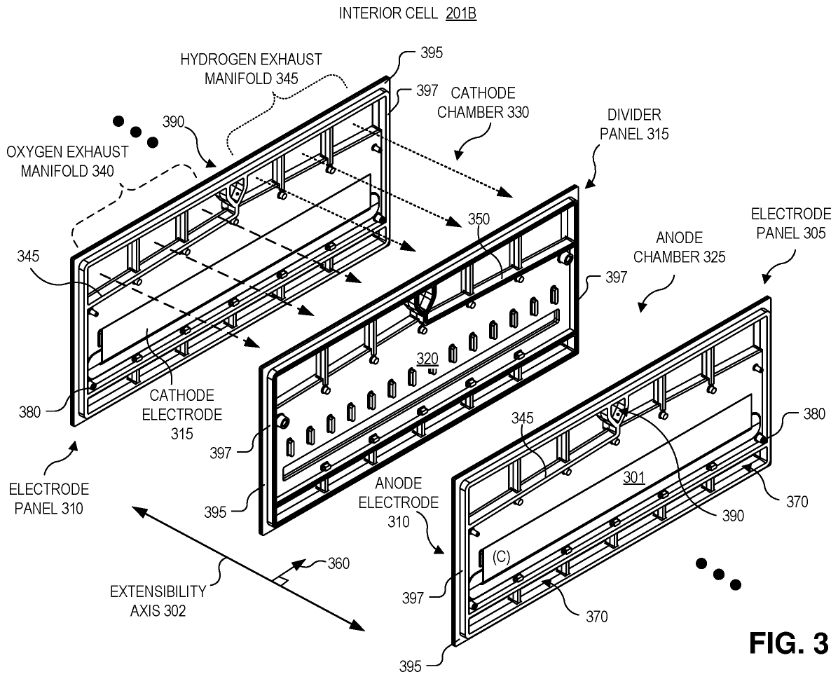

FIG. 3 illustrates how hydrogen electrolyzer cells 201 are extensible and stackable using a modular panel design, in accordance with an embodiment of the disclosure. The housing of interior cell 201B is assembled from two electrode panels 305 and 310 sandwiching a divider panel 315. Since cell 201B is an interior cell, its outer electrode panels 305 and 310 are shared by adjacent cells in stack 200. Multiple interior cells 201B may be stacked on either side of the illustrated interior cell 201B along extensibility axis 302. In other words, cathode electrode 301 is the cathode of an adjacent cell 201 (not illustrated in FIG. 3) while anode electrode 310 (hidden from view) and cathode electrode 315 form the electrodes of the instant interior cell 201B illustrated in FIG. 3. Thus, electrode panels 305 and 310 include embedded joint electrodes while divider panel 315 forms a dividing wall 320 between anode chamber 325 and cathode chamber 330. The joint electrodes may also be referred to as “bipolar electrodes” similar to bipolar plate electrodes used in conventional alkaline electrolyzers where one side of the electrode is negative and the other side is positive.

Electrode panels 305, 310 and divider panel 315 may be fabricated from a variety of materials; however, in one embodiment, they are fabricated from a common material, such as injection molded thermoplastic. The panels may be sealed together to form the housing structure of each cell using gaskets, hot-plate welding, adhesives, or otherwise. The extensibility comes from stacking multiple sets of panels together. In other embodiments, large stacks of cells may be fabricated using a one-step manufacturing process (rather than assembled from a set of pieces). For example, a stack of cells may be cast as a single part, 3D printed, etc. FIG. 3 also illustrates flanges 395 that extend along the perimeter of each electrode panel 305/310 and divider panel 315 and skirt the outer ledges 397. Ledges 397 are the raised locations for sealing adjacent panels using any of the afore mentioned techniques. Flanges 395 provide a structural extension for holding, aligning, and applying mechanical pressure during the assembly and sealing (e.g., hot-plate welding) processes. Ledges 397 may be melted together or include grooves for housing seals (e.g., gaskets, adhesive, etc.). Flanges 395 may also serve a dual purpose of operating as a cooling fin or turbulator to induce turbulent fluid flow over the exterior surfaces of a stack of cells (e.g., stacks 501) when exterior convective cooling is applied.

Electrode panels 305, 310 and divider panel 315 all include oxygen exhaust manifold 340 disposed laterally (along axis 360) to hydrogen exhaust manifold 345. When the panels are sealed together into stack 200, oxygen exhaust manifold 340 and hydrogen exhaust manifold 345 both extend through the entire stack 200. Ridges 345 press against dividing panel 315 sealing oxygen exhaust manifold 340 off from cathode chambers 330 while ridges 350 press against electrode panel 305 sealing hydrogen exhaust manifold 345 off from anode chambers 325. Ridges 345 and 350 alternate from one panel to the next in the stack up to ensure oxygen and hydrogen exhaust gases do not mix between their respective exhaust manifolds.

FIG. 3 further illustrates how heat exchange paths 370 are integrated into panels 305, 310, and 315. Each electrode panel 305 and 310 may further include an electrolyte equalization port 380 connecting one shared reservoir to another shared reservoir of an adjacent cell. These electrolyte equalization ports are passages through electrode panels 305 and 310 in the shared reservoir region to permit passage of the electrolyte solution during filling and draining and to help equalization of fill level 175 across multiple cells 201. To reduce the likelihood of shunt current paths between adjacent shared reservoirs, the electrolyte equalization ports are staggered side-to-side between electrode panels 305 and 310 to introduce a circuitous, high resistance electrical path between adjacent shared reservoirs.

FIG. 3 illustrates DI channel 390 that is formed when sandwiching the panels together. DI channel 390 couples to DI water ports 230 at either end of a stack of panels to replenishing water consumed in each cell during electrolysis and maintain electrolyte concentrations within defined bounds. A DI water injection port 135 may be a hole or embedded tube disposed on an interior surface of each electrode panel 305/310 within DI channel 390, or a notch disposed on a surface edge of each electrode panel 305/310 within DI channel 390. DI water injection ports 135 may share a common DI channel 390, but either feed into only anode chambers 110 or only cathode chambers 115. Including DI water injection ports 135 into both anode and cathode chambers may require separate DI channels 390, one-way values, or another mechanism to prevent combustible mixing of oxygen and hydrogen gases within DI channel 390.

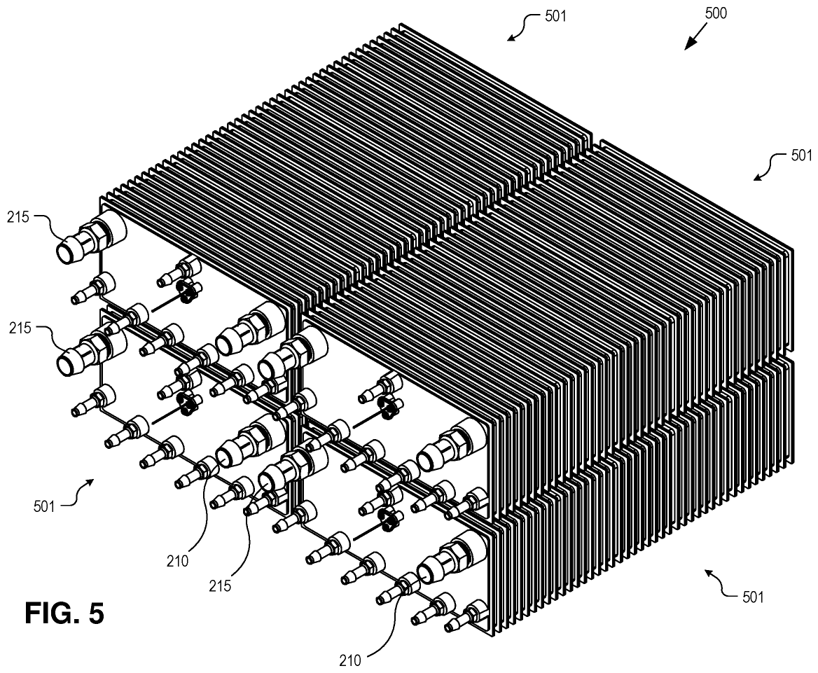

FIG. 5 is a perspective view illustration of an array 500 of stacks 501 of hydrogen electrolyzer cells coupled for large scale hydrogen production, in accordance with an embodiment of the disclosure. For example, a 1 MW electrolyzer array may include approximately 1400 stacks 501 with each stack 501 extending approximately 6 feet long for a total of 200,000 individual cells in the overall array 500. In a large array 500, oxygen manifold ports 210 and hydrogen manifold ports 215 may be connected to large external manifolds (not illustrated) where pressure regulators and gas sensors may be disposed to collectively regulate backpressures and monitor operation of stacks 501.

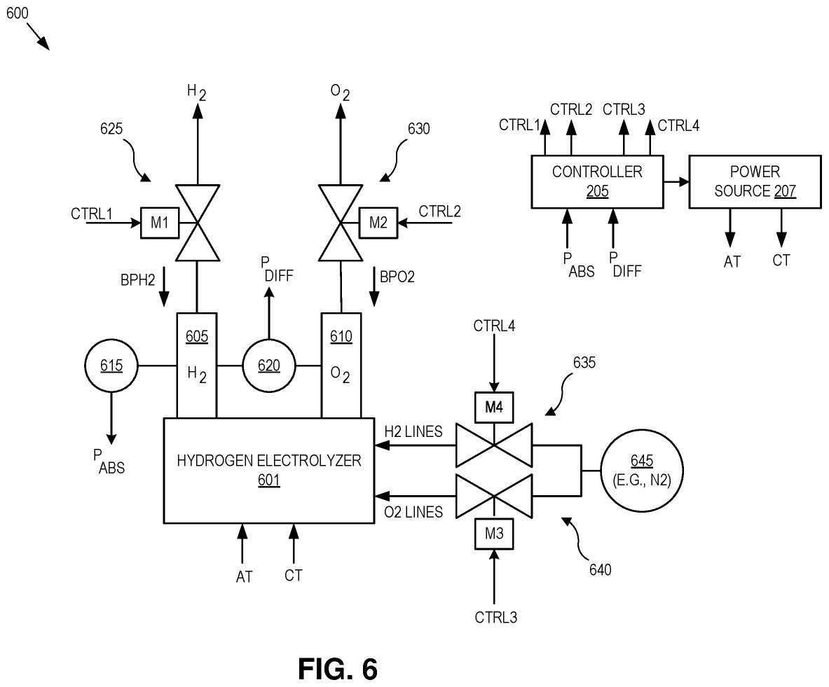

FIG. 6 is a functional block diagram illustrating components for regulating backpressures in a hydrogen electrolyzer system 600, in accordance with an embodiment of the disclosure. The illustrated embodiment of hydrogen electrolyzer system 600 includes a hydrogen electrolyzer 601 (e.g., cell 100, stack 200, array 500), a hydrogen exhaust manifold 605 (e.g., hydrogen exhaust manifold 165, hydrogen manifold port 215), an oxygen exhaust manifold 610 (e.g., oxygen exhaust manifold 150, oxygen manifold port 210), an absolute pressure sensor 615, a differential pressure sensor 620, valves 625, 630, 635, and 640, a purging tank 645, controller 205, and power source 207.

As mentioned above, hydrogen electrolyzer 601 generates hydrogen (H₂) and oxygen (O₂) gases during electrolysis. The hydrogen and oxygen gases are separated into hydrogen exhaust manifold 605 and oxygen exhaust manifold 610, respectively. Once sufficient hydrogen backpressure (BPH2) has built up within the manifold, valve 625 is actively controlled to regulate the release of hydrogen gas for collection and commercial use. Similarly, once sufficient oxygen backpressure (BPO2) has built up within oxygen exhaust manifold 610, valve 630 is actively controlled to regulate the release of oxygen, which may be exhausted to the atmosphere or collected for use. In various embodiments, valves 625 and 630 are motorized valves with motors M1 and M2, respectively, manipulated under the influence of controller 205. For example, the motorized valves may be implemented as motorized needle valves, motorized butterfly valves, etc. In various embodiments, valves 625 and 630 should be capable of operation with little to no backpressure, which conditions may exist during a startup phase of operation. As such, some conventional valves, such as solenoid valves, may not be suitable if backpressure is required for correct functioning.

Valve 625 controls the volumetric rate of release of hydrogen gas from hydrogen exhaust manifold 605 under the influence of controller 205 while valve 630 controls the volumetric rate of release of oxygen gas from oxygen exhaust manifold 610 also under the influence of controller 205. Controller 205 may be implemented as single, centralized controller or multiple decentralized controllers. Controller 205 includes control logic for orchestrating operation of the other functional components based upon sensor readings and control inputs. Controller 205 may be implemented in hardware, firmware, software, or any combination thereof.

Controller 205 is further coupled to absolute pressure sensor 615 to measure and monitor absolute pressure P_{ABS} in one of the exhaust manifolds (e.g., illustrated as hydrogen exhaust manifold 605 in FIG. 6) and coupled to differential pressure sensor 620 to measure and monitor the differential pressure P_{DIFF} between the two manifolds. The backpressures BPH2 and BPO2 in each of the manifolds are regulated (during steady-state operation) based upon the measured absolute pressure P_{ABS} and differential pressure P_{DIFF}. Absolute pressure sensor 615 measures the absolute pressure P_{ABS} within hydrogen exhaust manifold 605, which is a direct measure of hydrogen backpressure BPH2. Although absolute pressure P_{ABS} is referred to as an “absolute” pressure reading, it is appreciated that this is a term of convenience and absolute pressure P_{ABS} is relative to atmospheric pressure, which is defined as the zero reference pressure. In contrast, differential pressure sensor 620 measures the differential pressure between the hydrogen and oxygen exhaust manifolds. It is noteworthy that, in the illustrated embodiment, the backpressure of one of the exhaust manifolds (e.g., oxygen exhaust manifold 610) is not directly measured.

Hydrogen electrolyzer 601 may be operated at a variety of steady-state operating pressures. For example, in one embodiment, hydrogen electrolyzer 601 is operated at a steady state operating pressures of approximately 5 psi for each of PBH2 and BPO2 with a differential pressure P_{DIFF} of less than 3 mm water column height (i.e., 0.0042 psi) or to a level of precision necessary to ensure that both cathode and anode electrodes always remain bathed in the electrolyte solution. As such, differential pressure P_{DIFF} may be measured and monitored with greater precision than the absolute pressure P_{ABS} (e.g., two or three orders of magnitude greater precision). For example, pressure sensors 615 and 620 may each include a sensor that measure the flex, movement, or strain in a diaphragm with differential pressure sensor 620 having a more sensitive pliable rubber diaphragm than absolute pressure sensor 615, which may have a rigid metal diaphragm.

Valves 635 and 640 are purging valves that couple purging tank 645 to the manifolds and lines of hydrogen electrolyzer 601. Valves 635 and 640 may also be motorized valves manipulated by controller 205. Purging tank 645 stores a pressurized inert gas, such as nitrogen. During startup, controller 205 manages valves 635 and 640 to purge the system lines and manifolds. The purging process may include a 5× volumetric gas exchange of the cavities and lines within hydrogen electrolyzer 601 (including the exhaust manifolds and connecting lines). The purging may be done at near atmospheric pressure, or the purging gas may raise backpressures in a controlled manner to steady-state operating pressures (e.g., 5 psi) at which point electrolysis is commenced and the inert purging gas is slowly replaced with hydrogen and oxygen.

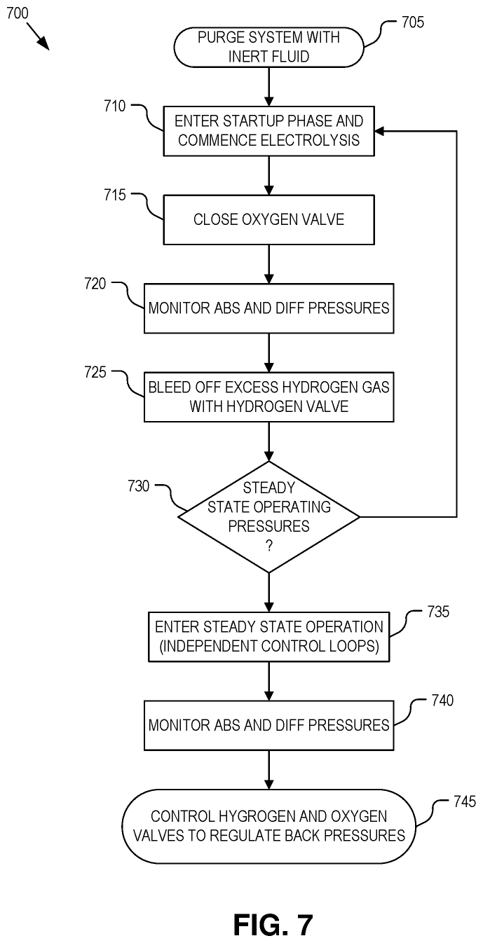

FIG. 7 is a flow chart illustrating a process 700 for starting up hydrogen electrolyzer system 600 and regulating backpressures during steady-state operation, in accordance with an embodiment of the disclosure. The order in which some or all of the process blocks appear in process 700 should not be deemed limiting. Rather, one of ordinary skill in the art having the benefit of the present disclosure will understand that some of the process blocks may be executed in a variety of orders not illustrated, or even in parallel.

In a process block 705, an idle hydrogen electrolyzer system 600 is first purged with an inert fluid (e.g., nitrogen gas) to purge the manifolds and connecting lines of any contaminating gases (e.g., air). Purging ensures that dangerous, combustible combinations of gases do not accumulate within the various cavities and lines. As a general rule of thumb, a volumetric transfer of inert gas through hydrogen electrolyzer 601, exhaust manifolds 605, 610, and the various connecting lines equal to 5× the volume to be purged establishes a safe, adequate system flush. Purging commences via actuation of motorized valves 635 and 640 under the influence of control signals CTRL3 and CTRL4 output from controller 205. Purging may be operated at or near atmospheric pressure, or be used to raise the internal pressures to steady-state operating pressures (e.g., 5 psi), before the onset of electrolysis and creation of oxygen and hydrogen gases. It should be appreciated that purging is not always necessary if the idle state of hydrogen electrolyzer system 600 maintained positive pressure and assured separation of the hydrogen and oxygen gases.

After an adequate flush/purge, hydrogen electrolyzer system 600 enters a startup phase with the commencement of electrolysis and the production of oxygen and hydrogen gases (process block 710). Electrolysis is commenced via application of bias potentials to the anode terminal AT and cathode terminal CT. During the startup phase, controller 205 closes valve 630 (process block 715) to facilitate the buildup of oxygen backpressure BPO2 in oxygen exhaust manifold 610. Valve 610 is closed during the startup phase because electrolysis produces twice as much hydrogen than oxygen by volume and thus the oxygen backpressure BPO2 takes longer to build than the hydrogen backpressure BPH2.

After commencing electrolysis, the absolute pressure P_{ABS} and differential pressure P_{DIFF} are monitored (process block 720) and the excess hydrogen gas is bleed off with valve 625 as the internal pressures rise. Once the steady-state operating pressures (e.g., P_{ABS}=5 psi and P_{DIFF}<0.0042 psi) are reached (decision block 730), the startup phase is complete and steady-state operation commences (process block 735). In the illustrated embodiment, once steady-state operation is reached, control over valves 625 and 630 is transitioned to distinct control loops. The absolute pressure P_{ABS} and the differential pressure P_{DIFF} are continuously monitored (process block 740) and valves 625 and 630 are controlled based upon these feedback signals (process block 745).

In one embodiment, the control loops manipulating valves 625 and 630 to regulate backpressures BPH2 and BPO2, respectively, are independent control loops. For example, the first control loop is an independent electronic control loop including absolute pressure P_{ABS}->controller 205->control signal CTRL1->valve 625. The second control loop is yet another independent electronic control loop including differential pressure P_{DIFF}->controller 205->control signal CTRL2->valve 630. In one embodiment, the first control loop manipulates valve 625 to regulate BPH2 without reference to the differential pressure P_{DIFF} and the second control loop manipulates valve 630 to regulate BPO2 without reference to absolute pressure P_{ABS}. These control loops may be electronic loops that manipulate valve motors M1 AND M2 with electronic signals CTRL1 and CTRL2, respectively, based upon electronic feedback signals P_{ABS} and P_{DIFF}, respectively, to regulate the flow of hydrogen and oxygen gases from their corresponding exhaust manifolds 605 and 610. Absolute pressure sensor 615 and differential pressure sensor 620 may both be implemented using electromechanical sensors having different sensitivities.

In one embodiment, controller 205 implements positional-integral-derivative (PID) control logic for each of the first and second control loops; however, it should be appreciated that other control algorithms may be implemented, and the specific control algorithms need not be the same between the two control loops. For example, one or both of the control loops may implement positional-derivative (PD) control algorithms. The slow changing nature of backpressures BPH2 and BPO2 and inherent mechanical dampening present in compressible gases may even lend itself to a positional (P) control algorithm, in some embodiments.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. At least one machine-accessible storage medium that provides instructions that, when executed by a controller of a hydrogen electrolyzer system, will cause the hydrogen electrolyzer system to perform operations comprising:
generating hydrogen and oxygen gases via electrolysis;
exhausting the hydrogen and oxygen gases to hydrogen and oxygen exhaust manifolds, respectively;
monitoring an absolute pressure in one of the hydrogen or oxygen exhaust manifolds;
monitoring a differential pressure between the hydrogen and oxygen exhaust manifolds; and
controlling backpressures in the hydrogen and oxygen exhaust manifolds based upon the absolute and differential pressures.

2. The at least one machine-accessible storage medium of claim 1, wherein the hydrogen electrolyzer system comprises a membraneless electrolyzer.

3. The at least one machine-accessible storage medium of claim 1, wherein the hydrogen electrolyzer system includes cathode and anode chambers in which cathode and anode electrodes, respectively, are bathed in a shared electrolytic solution that at least partially fills both of the cathode and anode chambers, wherein the cathode and anode chambers are not separated from each other by an electrolysis membrane.

4. The at least one machine-accessible storage medium of claim 3, wherein controlling the backpressures in the hydrogen or oxygen exhaust manifolds comprises:
controlling the differential pressure between the hydrogen and oxygen exhaust manifolds to within less than a threshold height differential of the shared electrolytic solution between the cathode and anode chambers, wherein the threshold height differential maintains both of the cathode and anode electrodes entirely bathed in the shared electrolytic solution during the electrolysis.

5. The at least one machine-accessible storage medium of claim 1, wherein controlling the backpressures in the hydrogen and oxygen exhaust manifolds comprises:
regulating the absolute pressure in the one of the hydrogen or oxygen exhaust manifolds with a first control loop; and
regulating the differential pressure between the hydrogen and oxygen exhaust manifolds with a second control loop, wherein the first and second control loops are independent of each other during steady state operation of the hydrogen electrolyzer system.

6. The at least one machine-accessible storage medium of claim 1, wherein monitoring the absolute pressure in the one of the hydrogen or oxygen exhaust manifolds comprises:
monitoring the absolute pressure in the hydrogen exhaust manifold.

7. The at least one machine-accessible storage medium of claim 6, wherein controlling the backpressures in the hydrogen and oxygen exhaust manifolds based upon the absolute and differential pressures comprises:
adjusting a first motorized valve coupled to the hydrogen exhaust manifold that controls a flow of the hydrogen gas from the hydrogen exhaust manifold based upon the absolute pressure; and
adjusting a second motorized valve coupled to the oxygen exhaust manifold that controls a flow of the oxygen gas from the oxygen exhaust manifold based upon the differential pressure.

8. The at least one machine-accessible storage medium of claim 7, wherein, during steady-state operation of the hydrogen electrolyzer system, the first motorized valve is controlled based upon the absolute pressure without reference to the differential pressure and the second motorized valve is controlled based upon the differential pressure without reference to the absolute pressure.

9. The at least one machine-accessible storage medium of claim 1, wherein controlling the backpressures in the hydrogen and oxygen exhaust manifolds based upon the absolute and differential pressures comprises regulating the differential pressure with greater precision than regulating the absolute pressure.

10. The at least one machine-accessible storage medium of claim 1, further providing instructions that, when executed by the controller, will cause the hydrogen electrolyzer system to perform further operations, comprising:
holding a first valve configured for discharging the oxygen gas from the oxygen exhaust manifold closed during a startup phase of the hydrogen electrolyzer system while raising the backpressures to steady state operating pressures;
bleeding the hydrogen gas from the hydrogen manifold with a second valve configured for discharging the hydrogen gas from the hydrogen exhaust manifold during the startup phase; and
transitioning control over the first and second valves to independent control loops when the backpressures reach the stead state operating pressures.

11. The at least one machine-accessible storage medium of claim 1, wherein controlling the backpressures in the hydrogen and oxygen exhaust manifolds comprises regulating the backpressures with motorized valves controlled by independent electronic control loops based upon the absolute and differential pressures obtained from electromechanical sensors.

12-20. (canceled)

21. A method of operation of a hydrogen electrolyzer system, the method comprising:
generating hydrogen and oxygen gases via electrolysis;
exhausting the hydrogen and oxygen gases to hydrogen and oxygen exhaust manifolds, respectively;
monitoring an absolute pressure in one of the hydrogen or oxygen exhaust manifolds;
monitoring a differential pressure between the hydrogen and oxygen exhaust manifolds; and
controlling backpressures in the hydrogen and oxygen exhaust manifolds based upon the absolute and differential pressures.

22. The method of claim 21, wherein the hydrogen electrolyzer system comprises a membraneless electrolyzer.

23. The method of claim 21, wherein the hydrogen electrolyzer system includes cathode and anode chambers in which cathode and anode electrodes, respectively, are bathed in a shared electrolytic solution that at least partially fills both of the cathode and anode chambers, wherein the cathode and anode chambers are not separated from each other by an electrolysis membrane.

24. The method of claim 23, wherein controlling the backpressures in the hydrogen or oxygen exhaust manifolds comprises:
controlling the differential pressure between the hydrogen and oxygen exhaust manifolds to within less than a threshold height differential of the shared electrolytic solution between the cathode and anode chambers, wherein the threshold height differential maintains both of the cathode and anode electrodes entirely bathed in the shared electrolytic solution during the electrolysis.

25. The method of claim 21, wherein controlling the backpressures in the hydrogen and oxygen exhaust manifolds comprises:
regulating the absolute pressure in the one of the hydrogen or oxygen exhaust manifolds with a first control loop; and
regulating the differential pressure between the hydrogen and oxygen exhaust manifolds with a second control loop, wherein the first and second control loops are independent of each other during steady state operation of the hydrogen electrolyzer system.

26. The method of claim 21, wherein monitoring the absolute pressure in the one of the hydrogen or oxygen exhaust manifolds comprises:
monitoring the absolute pressure in the hydrogen exhaust manifold.

27. The method of claim 26, wherein controlling the backpressures in the hydrogen and oxygen exhaust manifolds based upon the absolute and differential pressures comprises:
adjusting a first motorized valve coupled to the hydrogen exhaust manifold that controls a flow of the hydrogen gas from the hydrogen exhaust manifold based upon the absolute pressure; and
adjusting a second motorized valve coupled to the oxygen exhaust manifold that controls a flow of the oxygen gas from the oxygen exhaust manifold based upon the differential pressure.

28. The method of claim 27, wherein, during steady-state operation of the hydrogen electrolyzer system, the first motorized valve is controlled based upon the absolute pressure without reference to the differential pressure and the second motorized valve is controlled based upon the differential pressure without reference to the absolute pressure.

29. The method of claim 21, wherein controlling the backpressures in the hydrogen and oxygen exhaust manifolds based upon the absolute and differential pressures comprises regulating the differential pressure with greater precision than regulating the absolute pressure.
